(19) United States
(12) Patent Application Publication
(10) Pub. No.: US 2016/0072260 A1
(43) Pub. Date: Mar. 10, 2016

(54) Electrical Power Distribution and Conversion Assembly Suitable for Portable Work Platforms

(71) Applicant: Access Innovators, LLC, Norcross, GA (US)

(72) Inventor: Paul Mazurek, Cumming, GA (US)

(21) Appl. No.: 14/943,523

(22) Filed: Nov. 17, 2015

Related U.S. Application Data
(63) Continuation-in-part of application No. 14/132,474, filed on Dec. 18, 2013, now abandoned.
(60) Provisional application No. 61/826,520, filed on May 23, 2013.

(51) Int. Cl. H02B 1/26; H02H 3/16

(52) U.S. Cl. CPC H02B 1/26; H02H 3/16

(57) ABSTRACT

A portable power distribution and conversion assembly suitable for work platforms is disclosed. The assembly includes an encapsulated step-down transformer surrounded by an enclosure. The enclosure forms a single passage that receives a line-in electrical supply operating at a first voltage. The enclosure also forms a first set of passages that provide line-outs operating at the first voltage, and a second passage that provides a line-out operating at a second voltage that is greater than half the first voltage.

### CROSS-REFERENCE TO RELATED APPLICATIONS

This application is a continuation in part of and claims the benefit of the priority of U.S. Non-Provisional patent application Ser. No. 14/132,474, filed Dec. 18, 2013, and entitled “Electrical Power Distribution and Conversion Assembly Suitable for Portable Work Platforms,” which is hereby incorporated by reference in its entirety.

### TECHNICAL FIELD

This invention relates, in general, to portable electrical power distribution and voltage conversion for work platforms.

### BACKGROUND

Portable work platforms used for interior or exterior maintenance of a specific structure or a group of similar structures are known. These platforms provide a movable horizontal surface to support maintenance workers and their tools in the course of performing such tasks as window cleaning, caulking, metal polishing, window re-glazing, sealing and any other general maintenance task that must be performed from heights that range from a few feet above the ground or an interior ground floor to the top floor of a building, which in some circumstances can be several hundred feet above the ground. These portable work platforms are supported by structural cables and respective hoist mechanisms that enable the work platform to be controllably lowered or raised along the side of a building or other vertical structure. Generally, a 220VAC power source is provided to the platform. However, other input line voltages are possible. An independent splitter connects the line power to respective inputs of electric motors in the hoist mechanisms for raising or lowering the platform on the structural cable. Generally, the electric motors are placed at opposing ends of the work platform.

A transformer consists essentially of two coils of insulated wire. In most transformers, the wires are wound around an iron-containing structure called the core. One coil, called the primary, is connected to a source of alternating current that produces a constantly varying magnetic field around the coil. The varying magnetic field, in turn, produces an alternating current in the other coil. This other coil, i.e., the coil not connected to the source, is called the secondary, which is connected to a separate electric circuit.

The ratio of the number of turns in the primary coil to the number of turns in the secondary coil—the turns ratio—determines the ratio of the voltages in the two coils. For example, if there is one turn in the primary and ten turns in the secondary coil, the voltage in the secondary coil will be 10 times that in the primary. Such a transformer is called a step-up transformer. If there are ten turns in the primary coil and one turn in the secondary the voltage in the secondary will be one-tenth that in the primary. This type of transformer is called a step-down transformer. The ratio of the electric current flowing through the separate coils is in inverse proportion to the ratio of the voltages; thus the electrical power (voltage multiplied by amperage) is the same in both coils.

Field technicians preferably use an encapsulated step-down transformer to convert the 220VAC line power to provide 110VAC at an outlet suitable for powering hand-held tools. Frequently these conventional assemblies, which are often manufactured by the field technicians who deploy and support the portable work platforms, use a 1.5 kVA, 2 kVA, or 3 kVA coil. The selected coil is used to transform a 220VAC input to a 110VAC output via the secondary transformer winding. The secondary transformer winding is coupled to a single Ground Fault Circuit Interrupter (hereafter “GFCI”) receptacle, typically mounted on the front lower section of the encapsulated step-down transformer. A 220VAC output or “pigtail” is commonly provided by way of a passage or second knock-out through a side wall of the transformer enclosure. In conventional applications, the 220VAC output provided by the pigtail is connected to an independent 2-way yoke/splitter that conveys power to a pair of motor driven assemblies used to controllably position the work platform.

Such conventional arrangements are problematic. First, the placement of the single GFCI outlet on the front of the unit places the outlet, and the plugs/electrical cords connected to the outlet, in the relatively narrow work space provided for the workers and their equipment on the platform. As a result, a cover arranged on the GFCI is frequently damaged or even completely broken off by the workers. Such arrangements lead to possible injuries to the workers both from physical contact with the cover, plugs and cords, as well as from moisture-related dangers of electric shock to the workers. In addition, when the protective cover is damaged and/or completely broken off, the entire assembly is susceptible to circuit failure.

A second problem with such conventional arrangements is that the GFCI outlet typically included is rated for a total load of 20 amperes. Often this outlet is used to provide power to tools being used by two workmen on the portable platform. Consequently, the GFCI outlet is often overloaded and fails. Such failures lead to expensive service calls and lost opportunity costs due to downtime while the conventional assemblies are repaired.

Still another problem with the conventional arrangements is imposed by the common industry practice of reducing the 220VAC input to a 110VAC output. The 110VAC output results in an increased current draw through the outlet as power tools generally used on such platforms are designed to work optimally at 120VAC. Power tools operated under reduced voltage levels are inefficient as such use requires an increase in current. Long term operation of electrical power tools under such conditions can also significantly reduce the operational life of the tools.

### SUMMARY

In a first example embodiment, a portable power distribution and conversion assembly suitable for work platforms includes an enclosure that electrically isolates an encapsulated step-down transformer surrounded therein. The enclosure forms a first passage arranged to receive a line-in supply operating at a first voltage, a set of passages arranged to provide line-outs operating at the first voltage, and a second passage arranged to provide a line-out operating at a second voltage that is greater than half the first voltage.

In an alternative embodiment, a portable power distribution and conversion assembly suitable for work platforms includes an enclosure that electrically isolates an encapsulated step-down transformer. The enclosure forms a first passage that receives a line-in supply operating at a first voltage and a second passage that provides a line-out operating at a second voltage that is greater than half the first voltage.

In another example embodiment, a portable power distribution and conversion circuit suitable for work platforms includes a line-in supply that provides a first AC voltage, a step-down transformer having a primary winding coupled to the line-in supply and a secondary winding and a line-out coupled to the secondary winding that provides a second AC voltage that is greater than half the first AC voltage.

### BRIEF DESCRIPTION OF THE DRAWINGS

The portable power distribution and conversion assembly can be better understood with reference to the following drawings. The components in the drawings are not necessarily to scale, emphasis instead being placed upon clearly illustrating the principles of the assembly.

FIGS. 1A, 1B and 1C depict representative left-side, rear, and right-side plan views of an embodiment of an electrical power distribution and converter assembly suitable for portable work platforms.

FIG. 2 is a circuit diagram illustrating an embodiment of the electrical power distribution and converter assembly of FIGS. 1A, 1B and 1C.

### DETAILED DESCRIPTION OF THE ILLUSTRATED EMBODIMENTS

A number of improvements can be integrated into a novel and inventive electrical power distribution and converter assembly suitable for portable work platforms. As will be apparent to those skilled in the art, the separate improvements can be applied in any combination to improve portable power distribution assemblies used on portable work platforms. Among the several improvements includes a unique primary tap arrangement that produces an output voltage via a secondary winding or tap that is greater than half the supply voltage. This change in the secondary circuit reduces the current drawn by power tools operated on a portable work platform supported by the improved electrical power distribution and converter assembly. Such an arrangement reduces electric power needs and can extend the life of the tools used on the platform.

Furthermore, the improved arrangement includes the introduction of a circuit breaker or alternatively a fuse for current limiting the electrical current that can flow through the GFCI protected outlet. When a circuit breaker is introduced a reset mechanism may be provided via an opening in which the circuit breaker is mounted. When a fuse is introduced, a fuse port is inserted electrically between the secondary winding and one of the AC conductors of the GFCI protected outlet. The addition of an appropriately sized circuit breaker in series with the GFCI protected outlet reduces the number of service calls to replace overloaded outlets that have failed. Placement of the current limited and GFCI protected outlet on a side panel of the enclosure reduces the likelihood of injury to workers that might otherwise trip over electrical cords plugged into the outlets. Placement of the GFCI protected outlet on a side panel may further avoid damage to a protective outlet cover.

In addition, the improved arrangement includes an integrated line-voltage yoke circuit, which entirely removes the need for an independent yoke/splitter to provide electric power to motor driven hoists used to controllably adjust the vertical position of the portable work platform. The integrated yoke circuit entirely avoids the expense of purchasing an independent splitter assembly. In addition, commonly available extension cords in lengths matched to the size of the platform can be used to connect the electrically powered hoists to the 220VAC provided by the building to be maintained.

In an example embodiment, a portable power distribution and conversion assembly suitable for work platforms includes an enclosure that electrically isolates and surrounds an encapsulated step-down transformer. The enclosure, which can be manufactured from metal or other materials, includes a single passage through a wall of the enclosure to receive a line-in supply operating at a first voltage. The passage or opening for receiving the line-in supply is preferably located on a wall of the enclosure that will face the building rather than the opposed wall, which faces the interior of the work platform. The wall of the enclosure facing the workers on the platform is devoid of openings to reduce the safety hazards that result from unintended contact of workers with conductors, outlets, inlets and covers arranged on the front of an enclosure to protect these electrical interfaces. The line-in or supply voltage or supply from the building is introduced to the step-down transformer by way of an electrically insulated and weatherproof connector suitable for receiving 220VAC at greater than the expected loads of the hoist motors and power tools used on the work platform.

The remaining walls of the enclosure include a first set of passages or openings arranged to provide line-outs operating at the first voltage and a separate opening arranged to provide a line-out operating at a second voltage that is greater than half the first voltage. The line-outs operating at the first voltage include three electrically insulated conductors that are terminated with sockets in electrically insulated weatherproof connectors suitable for providing approximately 220VAC to the motors in the hoist mechanisms on the work platform. The line-out operating at the second voltage is terminated with a GFCI outlet rated to provide approximately 120VAC at 20 amperes to portable tools. The line-out operating at the second voltage is connected to the secondary coil of the step-down transformer. In a preferred arrangement, the GFCI outlet includes a weatherproof cover to prevent water or other elements from entering the outlet.

Each of the line-in and line-outs operating at the first or line-in voltage, the line-out operating at the second voltage, and the enclosure are coupled to a common electrical ground. The line-in is supported by a three-conductor insulated cable extending beyond an exterior surface of the enclosure from a single passage in the enclosure. The three-conductor insulated cable is terminated in an electrically insulated and weather proof connector. The electrically insulated and weather proof connector includes three electrically conductive tabs extending from a face of the connector. The line-outs operating at the line-in voltage, are supported by respective three conductor insulated cables that extend beyond opposed exterior surfaces of the enclosure. The respective electrically insulated cables that extend beyond the opposed surfaces of the enclosure are terminated in weather proof connectors.

In the example embodiment, the enclosure is arranged with a top surface an opposed bottom surface and a front surface that are devoid of passages. In use, the front surface is intended to face the interior of a work platform when the enclosure is engaged with the work platform.

In an optional embodiment, the electrical power distribution and converter assembly is arranged with a circuit breaker or fuse inserted along the “hot” lead between a secondary coil or a secondary winding of the encapsulated step-down transformer and the line-out protected by the circuit breaker or fuse and a GFCI. A suitably configured circuit breaker or fuse opens the line-out circuit before the GFCI suffers catastrophic damage.

In another optional embodiment, the electrical power distribution and converter assembly is arranged such that the line-out operating at the second voltage includes a neutral conductor coupled to electrical ground via a ground bond. So arranged, a GFCI outlet tester can be used to test operation of the GFCI protected line-out circuit.

In an example embodiment, the electrical power distribution and converter assembly is arranged with an integrated yoke that couples a respective set of conductors to an input connector to distribute the line-in voltage.

The enclosure of the portable power distribution and conversion assembly is arranged with a fixed bracket or brackets that extend from the rear wall of the enclosure. The brackets include at least one opening through the bracket for receiving an appendage of the work platform. When placed such that the openings receive the corresponding appendages of the work platform, the portable power distribution and conversion assembly can be safely secured to the work platform.

In an alternative embodiment, the input line voltage is approximately 208VAC. In this arrangement, the integrated yoke provides line-outs that operate at the input line voltage of 208VAC, while the step-down transformer is configured to supply 120VAC at 20 amperes to the GFCI outlet which is available to energize a motor in a tool.

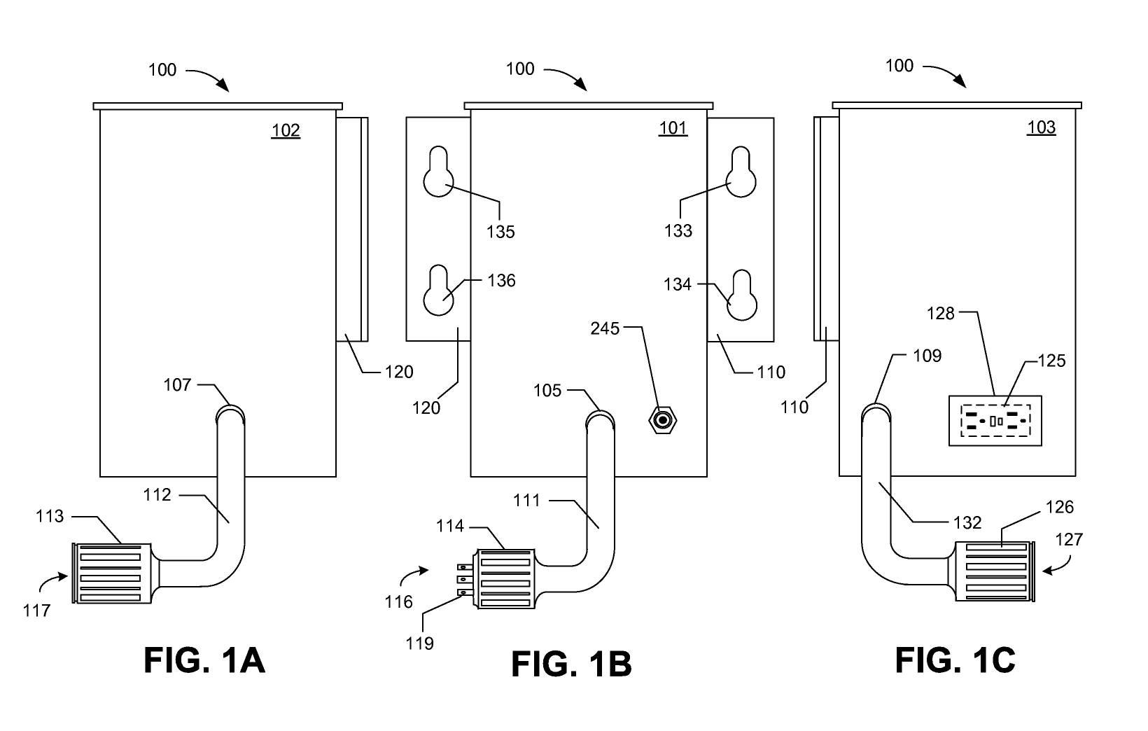

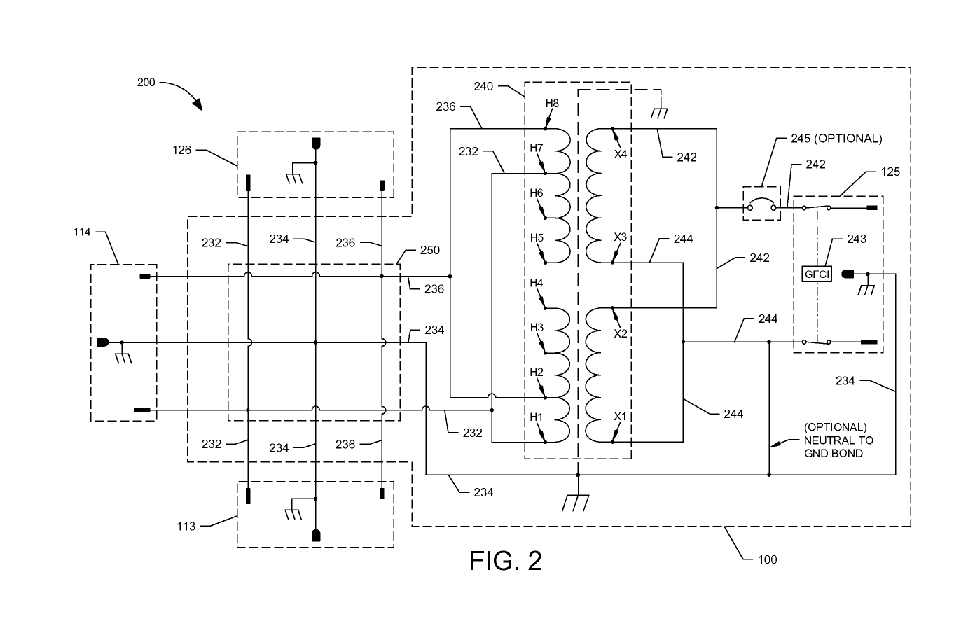

FIG. 1A-1C include left-side, rear, and right-side plan views respectively of a representative arrangement of an enclosure 100. As shown in FIG. 1A, a bracket 120 is fixed to the enclosure 100. The bracket 120 is available for supporting the portable power distribution and conversion assembly above the floor of the work platform (not shown). A left-side surface 102 forms a first passage or opening 107 in the left-side surface or panel 102. An electrically insulated three-conductor cable 112 extends beyond the left-side surface 102 and is terminated in a weatherproof connector 113. Connector face 117 includes three conductive sockets for completing a 220VAC circuit via an extension cord to a corresponding hoist motor on the work platform. Details of the 220VAC circuit and the GFCI supply circuit are shown and described in conjunction with FIG. 2.

As shown in FIG. 1C, a bracket 110 is fixed to the enclosure 100. The bracket 110 is available for supporting the portable power distribution and conversion assembly above the floor of the work platform. A right-side surface 103 forms a first passage or opening 109 in the right-side surface or panel 103. A second passage or opening is obscured by the GFCI outlet 125 mounted such that a face of the GFCI outlet 125 is accessible from the exterior of the enclosure 100. A weatherproof cover 128 is arranged about the GFCI outlet 125 to reduce the likelihood that water or other contaminants enter the GFCI outlet 125. When an operator needs to energize a 120 VAC power tool (not shown), the operator can rotate the weatherproof cover 128 to allow access to the electrical receptacles of the GFCI outlet 125. Otherwise, the weatherproof cover 128 may be closed to completely cover the electrical sockets of the GFCI outlet 125. An electrically insulated three-conductor cable 132 extends beyond the right-side surface 103 and is terminated in a weatherproof connector 126. Connector face 127 includes three conductive sockets for completing a 220VAC circuit via an extension cord to a corresponding hoist motor on the work platform.

FIG. 1B illustrates a rear plan view of the enclosure 100. Bracket 110 is fixed to the enclosure 100 and forms a first opening 133 and a second opening 134. As described above, the opening 133 and the opening 134 are arranged to receive corresponding appendages such as the head of a bolt or the end of a hook that is fixed to the work platform. Bracket 120 is fixed on an opposing surface of the enclosure 100. Bracket 120 forms a first opening 135 and a second opening 136. The first opening 135 and the second opening 136 are also arranged to receive corresponding appendages to safely secure the enclosure 100 of the portable power distribution and conversion assembly to the work platform.

A rearward facing surface 101 forms a first passage or opening 105. An optional circuit breaker 245 or fuse holder may also be provided in the rearward facing surface 101. Alternatively, the optional circuit breaker 245 or fuse holder may be provided in either the right-side surface 103 or the left-side surface 102.

An electrically insulated three-conductor cable 111 extends beyond the rearward facing surface 101 and is terminated in a weatherproof connector 114. Connector face 116 includes three conductive prongs or tabs 119 for completing a 220VAC circuit via an extension cord from a power source provided by the building or an alternative power source such as a portable generator.

FIG. 2 shows the portable power distribution and conversion assembly 200 schematically. An input circuit is formed by the connector 114, conductor 232, conductor 234, conductor 236, and primary windings of the encapsulated step-down transformer 240. A line-out or GFCI protected circuit is formed by GFCI 125, conductor 242 and conductor 244. The enclosure 100, encapsulated step-down transformer 240, integrated yoke 250, connector 113, connector 114, connector 126, circuit breaker 245 (optional) and GFCI outlet 125 are shown by way of dashed lines to provide reference with respect to the embodiment illustrated and described in association with FIGS. 1A-1C.

The step-down transformer 240 includes a primary winding or coil with taps H1 through H8 and a secondary winding or coil with taps X1-X4. Primary taps H2 and H8 are coupled via conductor 236 to the building supply via connector 114. A junction in integrated yoke 250 further couples taps H2 and H8 with a conductor in connector 113 and a corresponding conductor in connector 126. Primary taps H1 and H7 are coupled via conductor 232 to the building supply via connector 114. A junction in integrated yoke 250 further connects taps H1 and H7 with a conductor in connector 113 and a conductor in connector 126. Primary taps H3 through H6 are unused or not connected. As connected in the illustrated embodiment, the integrated yoke 250 provides the supply voltage or line-in voltage to each of connector 126, connector 113 and taps H1, H2, H7 and H8.

As further illustrated in FIG. 2, secondary taps X4 and X2 are coupled to GFCI 125 via conductor 242. Secondary taps X3 and X1 are coupled to GFCI 125 via conductor 244. When the primary and secondary windings of the encapsulated step-down transformer 240 are arranged in this manner, the voltage provided at the GFCI outlet 125 is greater than half the input or line-in

AC voltage provided by the building supply. For example, when the building supplied voltage is approximately 220VAC, the voltage at the GFCI outlet 125 and available for use when the assembly is energized is approximately 116VAC.

An input circuit is formed by the connector 114, conductor 232, conductor 234, conductor 236, and the primary winding of the encapsulated step-down transformer 240. The input circuit is generally provided an AC input voltage of 220VAC or 208VAC in accordance with a local or site supply of electrical energy. As indicated, the supply can be provided by a building or a portable electrical generator. Integrated yoke 250 is part of the input circuit. The integrated yoke 250 encompasses the conductive junctions that couple the connector 113 and the connector 126 to the line-in supply via connector 114. This input circuit can provide an AC input voltage for operating one or more electric motors for positioning a work platform.

An output or GFCI protected line-out circuit is formed by GFCI 125, conductor 242, conductor 244 and conductor 234. The GFCI protected line-out circuit provides a suitable AC voltage for operating power tools, work lights, etc. The GFCI 125 includes an internal circuit element 243 that monitors and interrupts the current flowing in the conductor 242 and the conductor 244 under certain conditions. For example, if the conductor 242 accidently is connected to ground such as when a worker accidently contacts an electrical conductor coupled to the conductor 242, the current surges in the conductor 242 but not in the conductor 244. When this is the case, the internal circuit element 243 disconnects the sockets in the GFCI 125 from the conductor 242 and the conductor 244, respectively.

The GFCI protected line-out circuit can optionally include a circuit breaker 245. The circuit breaker 245 opens or disconnects the conductor 242 when current flowing along the conductor 242 exceeds a threshold value of approximately N amperes, where N is an integer. In some embodiments the threshold value is about 15 A or 20 A. Thus, the circuit breaker 245, when present, prevents the adjusted or stepped voltage from continuing to reach the “hot” lead of the GFCI connector 125 under faulty load circuit conditions. This additional protection from optional circuit breaker 245 prevents the adjusted or stepped voltage from contact with electrical ground or the neutral conductor 244 of the GFCI 125, as such a condition results in a current that exceeds the threshold value. Such currents can damage supply circuits and portable electrical generators. Such currents can also damage the encapsulated step-down transformer 240, the GFCI 125, conductor 242 and neutral conductor 244, as well as damage any equipment plugged into the GFCI 125 (power tools, work lights, etc.). In an alternative embodiment, the circuit breaker 245 may be replaced by a fuse appropriately sized to open the circuit when the current in conductor 242 exceeds a desired threshold.

As indicated by conductor 234, each of the line-in connector 114, line-out connector 113 and line-out connector 126, operating at the first voltage and coupled to each other in the integral yoke 250, as well as the GFCI protected circuit or line-out, operating at the second or stepped-down voltage, and the enclosure 100 share a common electrical ground.

In contrast with conventional 2:1 step-down transformer arrangements, the relatively higher load voltage, as provided by the disclosed circuits and transformer, reduces load currents when power tools or other equipment are operated via the GFCI protected circuit. Such use has been known to exceed the current rating of the GFCI, which leads to frequent failures.

One or more illustrative or exemplary embodiments of the invention have been described above. However, it is to be understood that the improved power distribution and conversion assembly is defined by the appended claims and is not limited to the specific embodiments described. For example, as indicated above, the input line voltage may be closer to 208VAC than the illustrated and described input line voltage of 220VAC. When this is the case, the taps of the secondary winding or coil will be arranged to provide approximately 120VAC to the GFCI protected outlet coupled to the line out that operates at the second voltage.

[The remainder of this page is intentionally blank.]

Reference Numbers Introduced in the Illustrated Embodiments

| | |
|---|---|
| 100 | enclosure |
| 101 | rearward facing surface |
| 102 | left-side surface |
| 103 | right-side surface |
| 105 | passage |
| 107 | passage |
| 109 | passage |
| 110 | bracket |
| 111 | cable |
| 112 | cable |
| 113 | connector |
| 114 | connector |
| 116 | connector face |
| 117 | connector face |
| 119 | tabs |
| 120 | bracket |
| 125 | GFCI outlet |
| 126 | connector |
| 127 | connector face |
| 128 | weatherproof cover |
| 132 | cable |
| 133 | opening |
| 134 | opening |
| 135 | opening |
| 136 | opening |
| 200 | assembly |
| 232 | conductor |
| 234 | conductor |
| 236 | conductor |
| 240 | transformer |
| 242 | conductor |
| 243 | GFCI element |
| 244 | conductor |
| 245 | circuit breaker |

I claim:

1. A portable power distribution and conversion assembly suitable for a work platform, comprising:
an enclosure that electrically isolates an encapsulated step-down transformer surrounded therein, the enclosure arranged with:
a first passage arranged to receive a line-in supply operating at a first voltage,
a set of passages arranged to provide line-outs operating at the first voltage, and
a second passage arranged to provide a line-out operating at a second voltage that is greater than half the first voltage.

2. The assembly of claim 1, further comprising:
a third passage arranged to provide access to a current limiting device.

3. The assembly of claim 2, wherein the current limiting device is a circuit breaker.

4. The assembly of claim 2, wherein the current limiting device is a fuse.

5. The assembly of claim 1, wherein a respective set of conductors that traverse the enclosure through the first passage and the set of passages are coupled to one another in an integrated yoke arranged within the enclosure.

6. The assembly of claim 1, wherein the line-out operating at the second voltage includes a neutral conductor coupled to electrical ground via a ground bond.

7. The assembly of claim 1, wherein the line-in supply is provided via a cable coupled to a building.

8. The assembly of claim 7, wherein the line-in supply is approximately 220VAC.

9. The assembly of claim 1, further comprising:
a three-conductor insulated cable extending beyond an exterior surface of the enclosure from the first passage.

10. The assembly of claim 9, wherein the three-conductor insulated cable is terminated in an electrically insulated and weather proof connector.

11. The assembly of claim 10, wherein the electrically insulated and weather proof connector includes three electrically conductive tabs extending from a face of the connector.

12. The assembly of claim 1, further comprising:
a set of three-conductor insulated cables extending beyond an exterior surface of the enclosure from the set of passages.

13. The assembly of claim 12, wherein the set of three-conductor insulated cables extend beyond opposed walls of the enclosure and are terminated in respective electrically insulated and weather proof connectors capable of supplying adequate current to operate respective motors for controllably moving the work platform along structural cables suspended from a building.

14. The assembly of claim 13, wherein the respective electrically insulated and weather proof connectors each include three electrically conductive sockets.

15. The assembly of claim 1, further comprising:
a three-conductor ground fault protected socket mounted in the second passage and electrically coupled to the line-out operating at the second voltage.

16. The assembly of claim 15, wherein the three-conductor ground fault protected socket is arranged with a cover.

17. The assembly of claim 16, wherein the cover is weatherproof.

18. The assembly of claim 1, wherein the line-out operating at the second voltage is coupled to the secondary of the encapsulated step-down transformer.

19. The assembly of claim 18, wherein the secondary of the encapsulated step-down transformer is arranged to supply greater than 110VAC to a motor in a tool.

20. The assembly of claim 1, wherein the line-in and line-outs operating at the first voltage, the line-out operating at the second voltage, and the enclosure share a common electrical ground.

21. The assembly of claim 1, wherein the enclosure is arranged with at least one solid face.

22. The assembly of claim 21, wherein the at least one solid face of the enclosure faces the interior of the work platform when the enclosure is engaged with the work platform.

23. A portable power distribution and conversion assembly suitable for work platforms, comprising:
an enclosure that electrically isolates an encapsulated step-down transformer surrounded therein, the enclosure arranged with:
a first passage arranged to receive a line-in supply operating at a first voltage; and
a second passage arranged to provide a line-out operating at a second voltage that is greater than half the first voltage.

24. A portable power distribution and conversion circuit suitable for work platforms, comprising:
a line-in supply that provides a first AC voltage;
a step-down transformer having a primary winding coupled to the line-in supply and a secondary winding;
a line-out coupled to the secondary winding that provides a second AC voltage that is greater than half the first AC voltage.
